(19) United States
(12) Patent Application Publication
(10) Pub. No.: US 2014/0124037 A1
(43) Pub. Date: May 8, 2014

(54) METHODS OF MANIPULATING A DROPLET IN A DROPLET ACTUATOR

(71) Applicant: JENNIFER O. FOLEY, CARY, NC (US)

(72) Inventor: JENNIFER O. FOLEY, CARY, NC (US)

(73) Assignee: ADVANCED LIQUID LOGIC, INC., RESEARCH TRIANGLE PARK, NC (US)

(21) Appl. No.: 14/074,237

(22) Filed: Nov. 7, 2013

Related U.S. Application Data
(60) Provisional application No. 61/723,559, filed on Nov. 7, 2012.
(60) Provisional application No. 61/747,407, filed on Dec. 31, 2012.
(60) Provisional application No. 61/879,907, filed on Sep. 19, 2013.

(51) Int. Cl. B01L 3/00

(52) U.S. Cl. CPC B01L 3/50273
USPC 137/1; 422/504

(57) ABSTRACT

The invention relates to methods of manipulating a droplet in a droplet actuator. Methods of the invention utilize light alone or light in combination with droplet operations to, for example, pin droplets, split droplets, pattern surfaces, and/or sort droplets, particles, and/or cells.

### 1. RELATED APPLICATIONS

In addition to the patent applications cited herein, each of which is incorporated herein by reference, this patent application is related to and claims priority to U.S. Provisional Patent Application No. 61/723,559, filed on Nov. 7, 2012, entitled “Photoewod to Split, Sort and Pattern”; U.S. Provisional Patent Application No. 61/747,407, filed on Dec. 31, 2012, entitled “Photoelectrowetting Methods in a Droplet Actuator”; and U.S. Provisional Patent Application No. 61/879,907, filed on Sep. 19, 2013, entitled “Photoelectrowetting Methods in a Droplet Actuator”; the entire disclosures of which are incorporated herein by reference.

### 2. FIELD OF THE INVENTION

The invention relates to methods of manipulating a droplet in a droplet actuator. Methods of the invention utilize light alone or light in combination with droplet operations to, for example, pin droplets, split droplets, pattern surfaces, and/or sort droplets, particles, and/or cells.

### 3. BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. There is a need for new approaches to, for example, pinning, splitting, and sorting droplets in a droplet actuator.

### 4. BRIEF DESCRIPTION OF THE INVENTION

A method of manipulating a droplet in a droplet actuator is provided, including: (a) providing the droplet actuator, in which the droplet actuator includes a bottom substrate and a top substrate separated by a droplet operations gap; (b) applying a direct current (DC) voltage to the droplet; and (c) impinging at least a portion of the droplet with a beam of light energy; in which the droplet is manipulated by the combination of the DC voltage and the light energy. Manipulating the droplet may also include at least one of pinning the droplet, splitting the droplet, patterning a surface with the droplet, sorting a plurality of droplets, sorting a plurality of particles and/or cells within the droplet, or any combination thereof, particularly in which manipulating the droplet includes pinning the droplet. The droplet may also be manipulated by conducting droplet operations on the droplet. The light energy may be ultraviolet (UV) light energy. The droplet operations gap may include filler fluid, particularly a low-viscosity oil, more particularly silicone oil or hexadecane oil.

In one embodiment, the bottom substrate of the droplet actuator includes an arrangement of droplet operations electrodes. Droplet operations may be conducted atop the droplet operations electrodes. The droplet operations electrodes may include a conductor material, particularly in which the conductor material is gold or aluminum. The top substrate may include a ground reference plane. The ground reference plane and/or each of the droplet operations electrodes may also include a semiconductor material, particularly in which the semiconductor material is indium tin oxide (ITO) or poly(3,4-ethylenedioxythiophene) (PEDOT), more particularly in which ITO has a bandgap of greater than about 3 eV and PEDOT has a bandgap of between about 1.4 eV to about 2.5 eV. The ground reference plane may also include a conductive ink. The droplet may be atop a droplet operations electrode, particularly in which the droplet is a sample droplet. The top substrate and the ground reference plane also may each be substantially transparent to light, particularly ultraviolet (UV) light.

In another embodiment, manipulating the droplet includes pinning the droplet. The droplet may be pinned to the bottom substrate. Pinning the droplet may also include retaining the droplet at the droplet operations electrode in the absence of an electrowetting voltage, particularly in which the droplet is retained at the droplet operations electrode for at least 1 day or in which the droplet is retained at the droplet operations electrode for up to 2 days. The beam of light energy may impinge the droplet in its entirety, or the beam of light energy may impinge a portion of the droplet.

In another embodiment, an unpinned volume of the droplet may be transported away from the portion of the droplet impinged by the beam of light energy using droplet operations, further in which a smaller droplet is produced corresponding to the size of the beam of light energy. The size of the smaller droplet may be precisely controlled by controlling the size of the beam of light energy. The droplet may include adherent cells, further in which at least a portion of the droplet is pinned to a selected location on the droplet actuator to enable attachment of cells to the selected location on the droplet actuator.

In a further embodiment, manipulating the droplet may include patterning a surface with the droplet, particularly in which the pattern includes volumes of liquid that are smaller than an electrode.

In yet another embodiment, the droplet actuator further includes an on-actuator reservoir, particularly in which the on-actuator reservoir is configured to hold a volume of liquid. The volume of liquid may include a sample fluid or a liquid reagent. A reservoir electrode on the bottom substrate may be associated with the on-actuator reservoir. The DC voltage may be applied to the volume of liquid via the reservoir electrode and at least a portion of the volume of liquid may be impinged with a beam of light energy, particularly in which at least a portion of the volume of liquid is pinned inside the on-actuator reservoir. The volume of liquid inside the on-actuator reservoir may be pinned to the ground reference plane of the top substrate.

In another embodiment, manipulating the droplet may include sorting a plurality of droplets. At least one of the plurality of droplets may include a high concentration of opaque metal particles, a high density of cells, or a material that absorbs light energy, particularly in which droplets including the high concentration of opaque metal particles, the high density of cells, or the material that absorbs the light energy are transported using droplet operations. The method may further include measuring the impedence of the droplets before and after transport of the droplets using droplet operations and determining which droplets are pinned and which droplets are not pinned, particularly in which the determination of which droplets are pinned and which droplets are not pinned is used to determine the contents of the droplets.

In yet another embodiment, a microfluidics system is provided that is programmed to execute any of the methods disclosed herein for manipulating a droplet in a droplet actuator.

In a further embodiment, a storage medium is provided including program code embodied in the medium for executing any of the methods disclosed herein for manipulating a droplet in a droplet actuator.

In another embodiment, a microfluidics system is provided including a droplet actuator, in which the droplet actuator is coupled to a processor, and in which the processor executes program code embodied in a storage medium for executing any of the methods disclosed herein for manipulating a droplet in a droplet actuator.

### 5. BRIEF DESCRIPTION OF THE DRAWINGS

FIG. 1 illustrates a cross-sectional view of a portion of a droplet actuator and shows a method of using light to pin droplets on the top substrate of the droplet actuator;

FIGS. 2A and 2B illustrate a cross-sectional view of a portion of a droplet actuator and show a method of using tightly focused light to pin a droplet of a small precise volume;

FIG. 3 illustrates a cross-sectional view of a portion of a droplet actuator and shows a method of using light to pin liquid inside an on-actuator reservoir;

FIGS. 4A and 4B illustrate a cross-sectional view of a portion of a droplet actuator and show a method of using light to pin droplets on the bottom substrate of the droplet actuator;

FIGS. 5A and 5B illustrate a cross-sectional view of a portion of a droplet actuator and show a method of using light to sort droplets; and

FIG. 6 illustrates a functional block diagram of an example of a microfluidics system that includes a droplet actuator.

### 6. DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 1000 V, or about 300 V. Where alternating current is used, any suitable frequency may be employed. For example, an electrode may be activated using alternating current having a frequency from about 1 Hz to about 10 MHz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a flow path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/U.S. 2008/053545, entitled “Droplet Actuator Devices and Methods Employing Magnetic Beads,” filed on Feb. 11, 2008; International Patent Application No. PCT/U.S. 2008/058018, entitled “Bead-based Multiplexed Analytical Methods and Instrumentation,” filed on Mar. 24, 2008; International Patent Application No. PCT/U.S. 2008/058047, “Bead Sorting on a Droplet Actuator,” filed on Mar. 23, 2008; and International Patent Application No. PCT/U.S. 2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/U.S. 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/U.S. 2006/047486, entitled “Droplet-Based Biochemistry,” filed on Dec. 11, 2006; Shenderov, U.S. Pat. Nos. 6,773,566, entitled “Electrostatic Actuators for Microfluidics and Methods for Using Same,” issued on Aug. 10, 2004 and 6,565,727, entitled “Actuators for Microfluidics Without Moving Parts,” issued on Jan. 24, 2000; Kim and/or Shah et al., U.S. patent application Ser. Nos. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. Nos. 7,641,779, entitled “Method and Apparatus for Programmable fluidic Processing,” issued on Jan. 5, 2010, and 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting-mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/U.S. 2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.).; NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, Del.). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×- 3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200C, viscosity=2.4 cSt, d=1.79), Galden HT230 (bp=230C, viscosity=4.4 cSt, d=1.82) (all from Solvay Solexis); those in the Novec line, such as Novec 7500 (bp=128C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe3O4, BaFe12O19, CoO, NiO, Mn2O3, Cr2O3, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 7. DESCRIPTION

The invention is directed to methods of manipulating a droplet in a droplet actuator. For example, methods of the invention utilize light alone or light in combination with droplet operations to, for example, pin droplets, split droplets, pattern surfaces, and/or sort droplets, particles, and/or cells. “Pinning” means retaining a droplet or volume of liquid at a certain location in the droplet actuator in the absence of an electrowetting voltage.

According to the invention, because light can be very tightly focused, very small droplets of a precise volume can be formed using light. Further, the use of light to pin droplets, split droplets, and/or sort droplets reduces or entirely eliminates the need for other electronics. The capability to pin droplets or volumes of liquid inside a droplet actuator using light allows a droplet actuator cartridge to tolerate a certain amount of movement or handling without dislodging the droplets or volumes of liquid therein. Namely, the capability to pin droplets or volumes of liquid using light can be used advantageously to reduce or entirely eliminate leakage or flooding when handling droplet actuators.

It has been demonstrated that pinning of a droplet or volume of liquid can occur when light is shown on the droplet or volume of liquid at the same time that a DC voltage is applied to the electrode on which the droplet or liquid sits. Literature in the field of photoelectrowetting that supports this includes, for example, the reference article entitled “Moving liquids with light: Photoelectrowetting on semiconductors Ascott, S. et al. Issue 1:184 DOI:10.1038/srep00184 Scientific Reports; Dec 12, 2001. In the referenced article, wetting behavior can occur when voltage and light are applied to a liquid/insulator/semiconductor (LIS). By contrast, wetting behavior does not occur in a liquid/insulator/conductor (LIC) system.

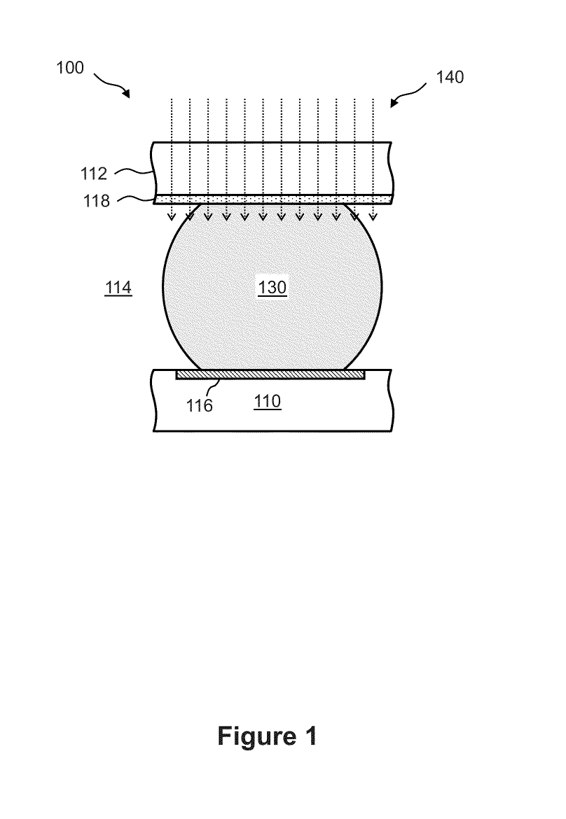

In a droplet actuator, the ground reference plane and/or the various electrodes (e.g., droplet operations electrodes and reservoir electrodes) can be formed of semiconductor materials, such as indium tin oxide (ITO) and PEDOT. PEDOT is an electrically conducting organic polymer. Therefore, conditions exist in a droplet actuator by which light may be used to pin droplets or volumes of liquid therein. The droplets or liquid are excited using light. The light in combination with applying a DC voltage initiates the pinning phenomenon. The higher energy light (particularly UV light) the more significant the pinning Examples of using light to pin droplets or volumes of liquid in a droplet actuator are described herein below with reference to FIGS. 1 through 5.

FIG. 1 illustrates a cross-sectional view of a portion of a droplet actuator 100 and shows a method of using light to pin droplets on the top substrate of droplet actuator 100. Droplet actuator 100 includes a bottom substrate 110 and a top substrate 112 that are separated by a droplet operations gap 114. Droplet operations gap 114 contains filler fluid (not shown). The filler fluid is, for example, low-viscosity oil, such as silicone oil or hexadecane filler fluid. Bottom substrate 110 may include an arrangement of droplet operations electrodes 116 (e.g., electrowetting electrodes). Droplet operations are conducted atop droplet operations electrodes 116 on a droplet operations surface. Top substrate 112 may include a ground reference plane (or electrode) 118.

In one example, droplet operations electrodes 116 on bottom substrate 110 are formed of a conductor material, such as gold or aluminum. Further, ground reference plane 118 of top substrate 112 is formed of a semiconductor material, such as ITO or PEDOT. Additionally, ground reference plane 118 can be formed of a conductive ink. It is unclear whether conductive ink is a semiconductor. However, the high resistivity of the conductive ink, which is about ˜1 kΩ, can lead to a charge build up thereon. Further, the thickness and uniformity of the materials influence their conductive properties.

FIG. 1 shows a droplet 130 in the droplet operations gap 114 and sitting atop one droplet operations electrode 116. Droplet 130 is, for example, a sample droplet.

At the same time that a DC voltage is applied to the droplet operations electrode 116, droplet 130 is exposed to light energy 140 for a certain period of time. Light energy 140 is, for example, UV light. Therefore, top substrate 112 and ground reference plane 118 must be substantially transparent to UV light. In this example, light energy 140 impinges ground reference plane 118, which is a semiconductor, and droplet 130, thereby pinning droplet 130 to ground reference plane 118 of substrate 112. The illumination of the droplet 130 in combination with applying a DC voltage to the droplet operations electrode 116 initiates the pinning phenomenon. Once pinned, droplet 130 is retained at the droplet operations electrode 116 in the absence of the electrowetting voltage. The pinning phenomenon may last for up to about 1-2 days.

The excitation wavelength, the bandgap of the semiconductor material, and the thickness and uniformity of the semiconductor material may influence the pinning effect. The bandgap of PEDOT is ˜1.4-2.5 eV. The bandgap of ITO is >3 eV.

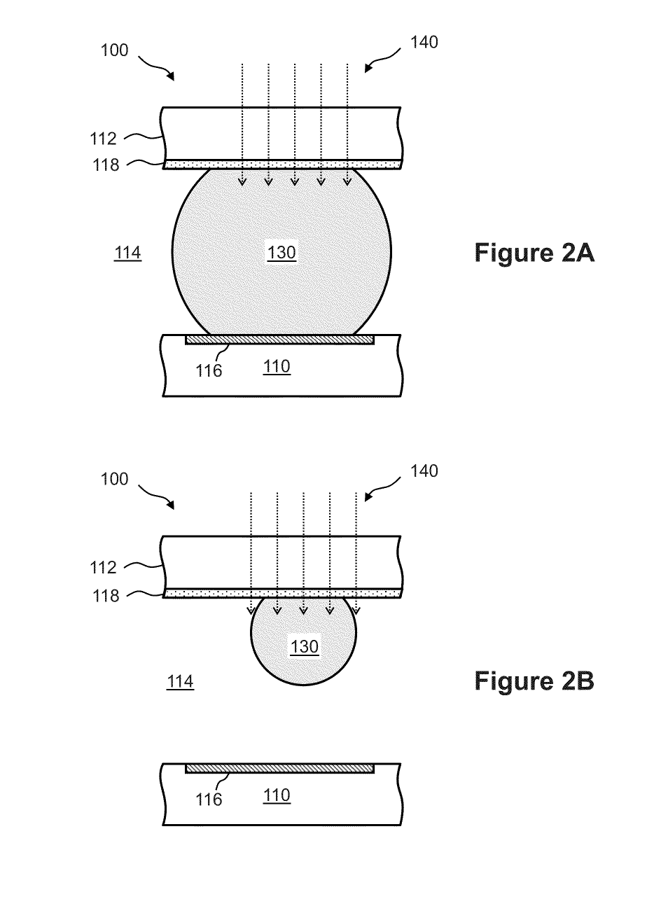

FIGS. 2A and 2B illustrate a cross-sectional view of a portion of droplet actuator 100 and show a method of using tightly focused light to pin a droplet of a small precise volume. FIG. 2A shows a tightly focused beam of light energy 140 impinging droplet 130, wherein the tightly focused beam of light energy 140 impinges only a portion of droplet 130, in contrast to FIG. 1 in which light energy 140 impinges the entirety of droplet 130.

Referring now to FIG. 2B, by impinging only a portion of droplet 130, the unpinned volume of the original droplet 130 can be transported away using droplet operations, leaving behind a small droplet 130 that corresponds to the size of the beam of light energy 140. In this example, the small droplet 130 is pinned to ground reference plane 118 of top substrate 112. By precisely controlling the beam of light energy 140, the size of droplet 130 that is pinned can be precisely controlled.

Accordingly, light provides significantly improved volume control as compared with using strictly droplet operations to form droplets. For example, light can be used to pin or pattern liquids directly to a surface at feature sizes achievable only by light so that particles/chemistries in the droplet attach well to the surface. Additionally, light can be used to pin a droplet containing adherent cells so that they can immediately attach to the droplet actuator in a very precise location. Because the locations at which pinning occurs correlate with the pattern at which light impinges on the droplet actuator, one can imagine patterning or pinning liquids at very small optical scales (smaller than an electrode) using the appropriate optics. Further, because splitting liquids can be difficult in certain droplet actuator configurations, the use of light to pin a portion of the droplet while pulling away the unpinned portion can be a method of splitting the droplet.

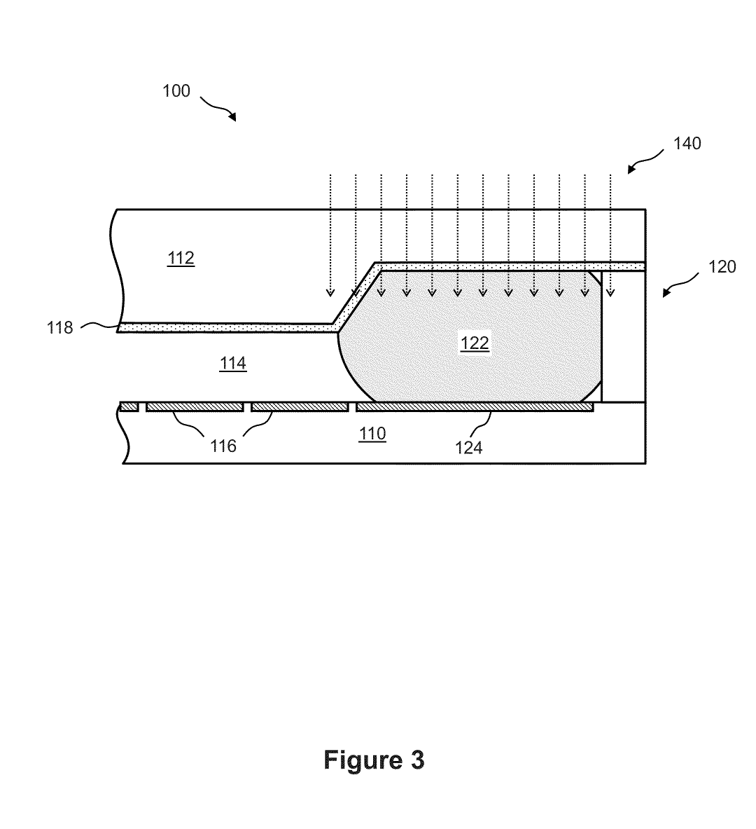

FIG. 3 illustrates a cross-sectional view of a portion of droplet actuator 100 and shows a method of using light to pin liquid inside an on-actuator reservoir. FIG. 3 shows an on-actuator reservoir 120 is integrated into droplet actuator 100 for holding a volume of liquid 122. Liquid 122 is, for example, sample fluid or liquid reagent. A reservoir electrode 124 on bottom substrate 110 is associated with on-actuator reservoir 120.

In order to reduce or entirely eliminate any risk of flooding or liquid drift, particularly if droplet actuator 100 undergoes significant movement (e.g., in a point of care situation), liquid 122 can be pinned inside on-actuator reservoir 120. At the same time that a DC voltage is applied to reservoir electrode 124, liquid 122 is exposed to light energy 140 for a certain period of time. In so doing, the volume of liquid 122 inside on-actuator reservoir 120 is pinned to ground reference plane 118 of top substrate 112. In this example, the larger the surface area of the ground reference plane 118, the better the pinning

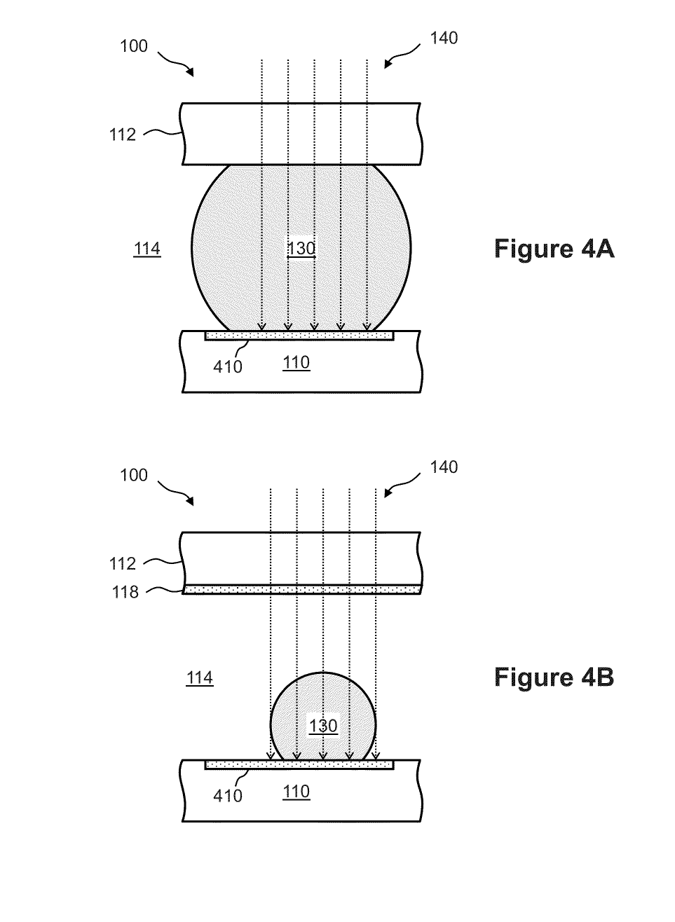

The invention is not limited to pinning liquid to the top substrate only. Liquid can be pinned to the top substrate, to the bottom substrate 110, or to both. An example of pinning liquid to the bottom substrate is shown with reference to FIGS. 4A and 4B below.

FIGS. 4A and 4B illustrate a cross-sectional view of a portion of droplet actuator 100 and show a method of using light to pin droplets on bottom substrate 110 of droplet actuator 100. In this example, droplet actuator 100 includes an arrangement of droplet operations electrodes 410 atop bottom substrate 110. In this example, droplet operations electrodes 410 are formed of a semiconductor material rather than a conductor material. For example, the droplet operations electrodes 410 are formed of ITO or PEDOT.

FIG. 4A shows a tightly focused beam of light energy 140 impinging droplet 130, wherein the tightly focused beam of light energy 140 impinges only a portion of droplet 130. Referring now to FIG. 4B, by impinging only a portion of droplet 130, a certain volume of the original droplet 130 can be transported away using droplet operations, leaving behind a small droplet 130 that corresponds to the size of the beam of light energy 140. In this example, the small droplet 130 is pinned to the droplet operations electrode 410 of bottom substrate 110.

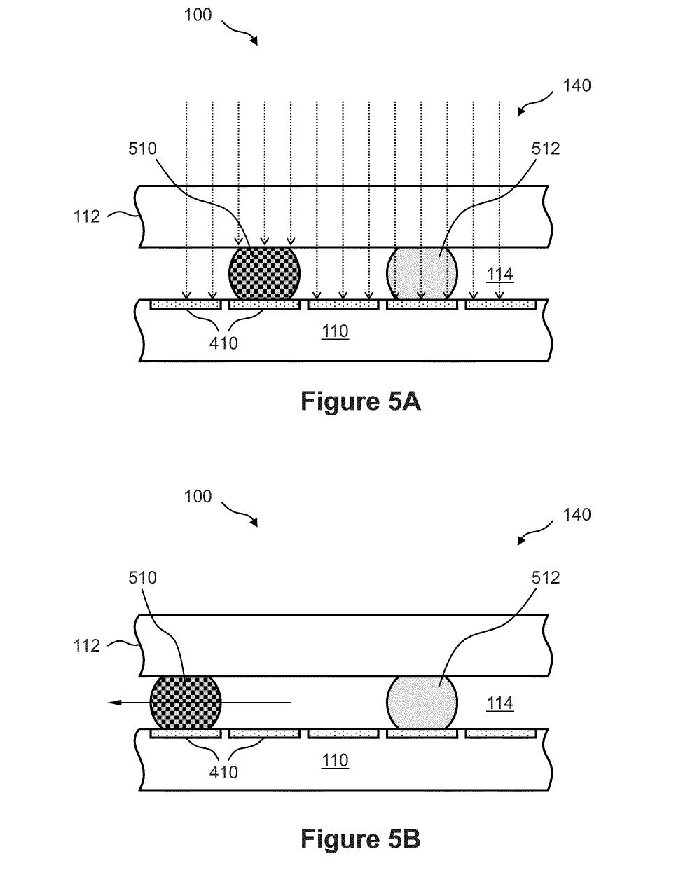

FIGS. 5A and 5B illustrate a cross-sectional view of a portion of droplet actuator 100 and show a method of using light to sort droplets. In a droplet actuator configuration in which the pinning occurs on the side of the droplet that is opposite the light source, such as shown in FIGS. 4A and 4B, certain droplets can be pinned or not pinned depending on the optical properties of the droplet. The optical properties are determined by the contents of the droplet. For example, a droplet containing a high concentration of opaque metal particles, a high density of cells, or material that absorbs the wavelength of illuminating light before impinging the semiconductor material will result in no pinning. As a result, only the droplets that contain these materials can be transported away by droplet operations. This method, in combination with impedance measurements, may reduce or entirely eliminate the need for optical detection. Instead, this method requires an illumination step, followed by a droplet operations step to attempt to transport the droplets, followed by a snapshot step in which a snapshot of the droplet actuator is taken and then compared to the illumination pattern. In so doing, it is determined which droplets are pinned and which droplets are not pinned.

By way of example, FIG. 5A shows a droplet 510 and a droplet 512 in the droplet operations gap 114 of droplet actuator 100. In this example, droplet 510 includes a high concentration of opaque metal particles, a high density of cells, or material that absorbs the wavelength of illuminating light. As a result, droplet 510 blocks light energy 140 from impinging the semiconductor material of the droplet operations electrode 410. By contrast, droplet 512 does not include a high concentration of opaque metal particles, a high density of cells, or material that absorbs the wavelength of illuminating light. As a result, droplet 512 does not block light energy 140 from impinging the droplet operations electrode 410. Consequently, droplet 512 is pinned while droplet 510 is not pinned, as shown in FIG. 5B. The determination that droplet 510 is not pinned and that droplet 512 is pinned is used to determine the contents of droplet 510 and droplet 512, respectively.

### 7.1 SYSTEMS

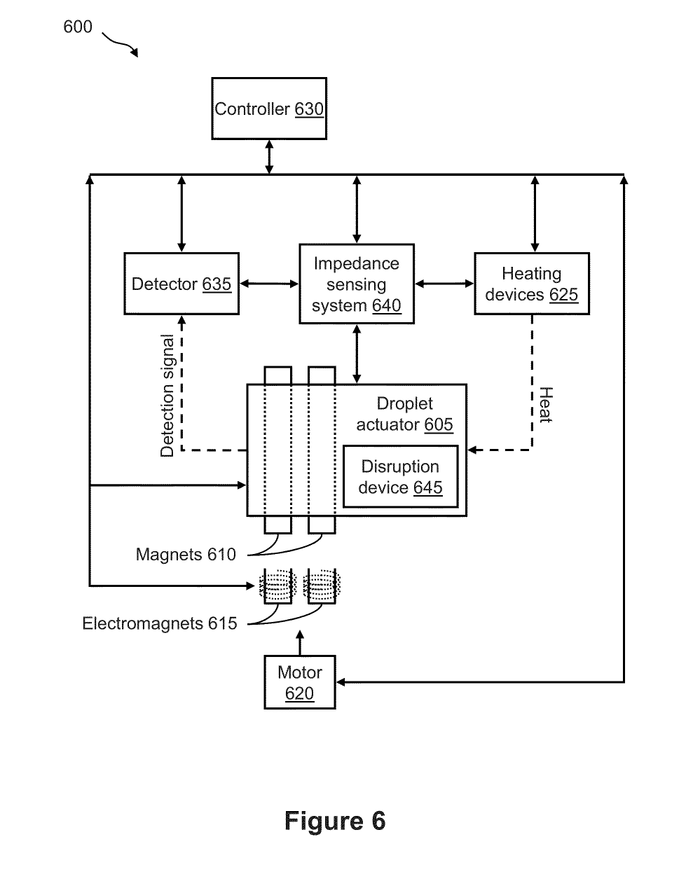

FIG. 6 illustrates a functional block diagram of an example of a microfluidics system 600 that includes a droplet actuator 605. Digital microfluidic technology conducts droplet operations on discrete droplets in a droplet actuator, such as droplet actuator 605, by electrical control of their surface tension (electrowetting). The droplets may be sandwiched between two substrates of droplet actuator 605, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 605 may be designed to fit onto an instrument deck (not shown) of microfluidics system 600. The instrument deck may hold droplet actuator 605 and house other droplet actuator features, such as, but not limited to, one or more magnets and one or more heating devices. For example, the instrument deck may house one or more magnets 610, which may be permanent magnets. Optionally, the instrument deck may house one or more electromagnets 615. Magnets 610 and/or electromagnets 615 are positioned in relation to droplet actuator 605 for immobilization of magnetically responsive beads. Optionally, the positions of magnets 610 and/or electromagnets 615 may be controlled by a motor 620. Additionally, the instrument deck may house one or more heating devices 625 for controlling the temperature within, for example, certain reaction and/or washing zones of droplet actuator 605. In one example, heating devices 625 may be heater bars that are positioned in relation to droplet actuator 605 for providing thermal control thereof.

A controller 630 of microfluidics system 600 is electrically coupled to various hardware components of the invention, such as droplet actuator 605, electromagnets 615, motor 620, and heating devices 625, as well as to a detector 635, an impedance sensing system 640, and any other input and/or output devices (not shown). Controller 630 controls the overall operation of microfluidics system 600. Controller 630 may, for example, be a general purpose computer, special purpose computer, personal computer, or other programmable data processing apparatus. Controller 630 serves to provide processing capabilities, such as storing, interpreting, and/or executing software instructions, as well as controlling the overall operation of the system. Controller 630 may be configured and programmed to control data and/or power aspects of these devices. For example, in one aspect, with respect to droplet actuator 605, controller 630 controls droplet manipulation by activating/deactivating electrodes.

In one example, detector 635 may be an imaging system that is positioned in relation to droplet actuator 605. In one example, the imaging system may include one or more light-emitting diodes (LEDs) (i.e., an illumination source) and a digital image capture device, such as a charge-coupled device (CCD) camera.

Impedance sensing system 640 may be any circuitry for detecting impedance at a specific electrode of droplet actuator 605. In one example, impedance sensing system 640 may be an impedance spectrometer. Impedance sensing system 640 may be used to monitor the capacitive loading of any electrode, such as any droplet operations electrode, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

Droplet actuator 605 may include disruption device 645. Disruption device 645 may include any device that promotes disruption (lysis) of materials, such as tissues, cells and spores in a droplet actuator. Disruption device 645 may, for example, be a sonication mechanism, a heating mechanism, a mechanical shearing mechanism, a bead beating mechanism, physical features incorporated into the droplet actuator 605, an electric field generating mechanism, a thermal cycling mechanism, and any combinations thereof. Disruption device 645 may be controlled by controller 630.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### 8. CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

We claim:

1. A method of manipulating a droplet in a droplet actuator comprising:
(a) providing the droplet actuator, wherein the droplet actuator comprises a bottom substrate and a top substrate separated by a droplet operations gap;
(b) applying a direct current (DC) voltage to the droplet; and
(c) impinging at least a portion of the droplet with a beam of light energy;
wherein the droplet is manipulated by the combination of the DC voltage and the light energy.

2. The method of claim 1, wherein the droplet is also manipulated by conducting droplet operations on the droplet.

3. The method of claim 1, wherein manipulating the droplet comprises at least one of pinning the droplet, splitting the droplet, patterning a surface with the droplet, sorting a plurality of droplets, sorting a plurality of particles and/or cells within the droplet, or any combination thereof.

4. The method of claim 3, wherein manipulating the droplet comprises pinning the droplet.

5. The method of claim 3, wherein the light energy is ultraviolet (UV) light energy.

6. The method of claim 3, wherein the droplet operations gap comprises filler fluid.

7. The method of claim 6, wherein the filler fluid comprises a low-viscosity oil.

8. The method of claim 7, wherein the low-viscosity oil is selected from the group consisting of silicone oil and hexadecane oil.

9. The method of claim 3, wherein the bottom substrate comprises an arrangement of droplet operations electrodes.

10. The method of claim 9, wherein droplet operations are conducted atop the droplet operations electrodes.

11. The method of claim 10, wherein the droplet operations electrodes comprise a conductor material.

12. The method of claim 11, wherein the conductor material is selected from the group consisting of gold and aluminum.

13. The method of claim 10, wherein the top substrate comprises a ground reference plane.

14. The method of claim 13, wherein the ground reference plane and/or each of the droplet operations electrodes comprises a semiconductor material.

15. The method of claim 14, wherein the semiconductor material is selected from the group consisting of indium tin oxide (ITO) and poly(3,4-ethylenedioxythiophene) (PEDOT).

16. The method of claim 15, wherein the semiconductor material is ITO, further wherein the ITO has a bandgap of greater than about 3 eV.

17. The method of claim 15, wherein the semiconductor material is PEDOT, further wherein the PEDOT has a bandgap of between about 1.4 eV to about 2.5 eV.

18. The method of claim 13, wherein the ground reference plane comprises a conductive ink.

19. The method of claim 10, wherein the droplet is atop a droplet operations electrode.

20. The method of claim 19, wherein the droplet is a sample droplet.

21. The method of claim 13, wherein the top substrate and the ground reference plane are each substantially transparent to light.

22. The method of claim 13, wherein the top substrate and the ground reference plane are each substantially transparent to ultraviolet (UV) light.

23. The method of claim 22, wherein manipulating the droplet comprises pinning the droplet.

24. The method of claim 23, wherein the droplet is pinned to the bottom substrate.

25. The method of claim 23, wherein pinning the droplet comprises retaining the droplet at the droplet operations electrode in the absence of an electrowetting voltage.

26. The method of claim 25, wherein the droplet is retained at the droplet operations electrode for at least 1 day.

27. The method of claim 25, wherein the droplet is retained at the droplet operations electrode for up to 2 days.

28. The method of claim 24, wherein the beam of light energy impinges the droplet in its entirety.

29. The method of claim 24, wherein the beam of light energy impinges a portion of the droplet.

30. The method of claim 29, wherein an unpinned volume of the droplet is transported away from the portion of the droplet impinged by the beam of light energy using droplet operations, further wherein a smaller droplet is produced corresponding to the size of the beam of light energy.

31. The method of claim 30, wherein the size of the smaller droplet is precisely controlled by controlling the size of the beam of light energy.

32. The method of claim 23, wherein the droplet comprises adherent cells, further wherein at least a portion of the droplet is pinned to a selected location on the droplet actuator to enable attachment of cells to the selected location on the droplet actuator.

33. The method of claim 22, wherein manipulating the droplet comprises patterning a surface with the droplet.

34. The method of claim 33, wherein the pattern comprises volumes of liquid that are smaller than an electrode.

35. The method of claim 23, wherein the droplet actuator further comprises an on-actuator reservoir.

36. The method of claim 35, wherein the on-actuator reservoir is configured to hold a volume of liquid.

37. The method of claim 36, wherein the volume of liquid comprises a sample fluid or a liquid reagent.

38. The method of claim 37, wherein a reservoir electrode on the bottom substrate is associated with the on-actuator reservoir.

39. The method of claim 38, wherein the DC voltage is applied to the volume of liquid via the reservoir electrode and wherein at least a portion of the volume of liquid is impinged with a beam of light energy.

40. The method of claim 39, wherein at least a portion of the volume of liquid is pinned inside the on-actuator reservoir.

41. The method of claim 39, wherein the volume of liquid inside the on-actuator reservoir is pinned to the ground reference plane of the top substrate.

42. The method of claim 22, wherein manipulating the droplet comprises sorting a plurality of droplets.

43. The method of claim 42, wherein at least one of the plurality of droplets comprises a high concentration of opaque metal particles, a high density of cells, or a material that absorbs light energy.

44. The method of claim 43, wherein droplets comprising the high concentration of opaque metal particles, the high density of cells, or the material that absorbs the light energy are transported using droplet operations.

45. The method of claim 44, further comprising measuring the impedence of the droplets before and after transport of the droplets using droplet operations and determining which droplets are pinned and which droplets are not pinned.

46. The method of claim 45, wherein the determination of which droplets are pinned and which droplets are not pinned is used to determine the contents of the droplets.

47. A microfluidics system programmed to execute the method of claim 1 for manipulating a droplet in a droplet actuator.

48. A storage medium comprising program code embodied in the medium for executing the method of claim 1 for manipulating a droplet in a droplet actuator.

49. A microfluidics system comprising a droplet actuator, wherein the droplet actuator is coupled to a processor, and wherein the processor executes program code embodied in a storage medium for executing the method of claim 1 for manipulating a droplet in a droplet actuator.
